(19) United States
(12) Patent Application Publication
(10) Pub. No.: US 2014/0376515 A1
(43) Pub. Date: Dec. 25, 2014

(54) METHODS, APPARATUSES AND COMPUTER PROGRAM PRODUCTS FOR WLAN DISCOVERY AND HANDOVER IN COEXISTED LTE AND WLAN NETWORKS

(71) Applicants: Yixue Lei, Beijing (CN); Mikko Aleksi Uusitalo, Helsinki (FI); Yang Liu, Beijing (CN); Haitao Li, Beijing (CN); Enrico-Henrik Rantala, Ilttala (FI); Antti Sorri, Helsinki (FI); Esa Malkamaki, Espoo (FI)

(72) Inventors: Yixue Lei, Beijing (CN); Mikko Aleksi Uusitalo, Helsinki (FI); Yang Liu, Beijing (CN); Haitao Li, Beijing (CN); Enrico-Henrik Rantala, Ilttala (FI); Antti Sorri, Helsinki (FI); Esa Malkamaki, Espoo (FI)

(73) Assignee: Nokia Corporation, Espoo (FI)

(21) Appl. No.: 14/374,915

(22) PCT Filed: Feb. 17, 2012
(86) PCT No.: PCT/CN2012/071287

§ 371 Date: Sep. 2, 2014

(51) Int. Cl. H04W 48/16; H04W 36/08; H04W 36/00

(52) U.S. Cl. CPC H04W 48/16; H04W 36/0055; H04W 36/08
USPC 370/331

(57) ABSTRACT

Provided are methods, corresponding apparatuses, and computer program products for triggering WLAN discovery and handover procedures in coexisted LTE and WLAN networks. A method comprises receiving, from a first base station, information that has been exchanged 5 between the first evolve Node B and a second base station and that relates to at least one wireless local area network access point connected or co-located with the first base station or the second base station; and performing a wireless local area network discovery procedure with the at least one wireless local area network access point based upon the received information. With the claimed inventions, signaling cost and power consumption by those unnecessary WLAN 10 discovery procedures could be avoided, acquiring a longer battery life for a user equipment.

### FIELD OF THE INVENTION

Embodiments of the present invention generally relate to wireless communication techniques including the 3GPP LTE and WLAN techniques. More particularly, embodiments of the present invention relate to methods, apparatuses, and computer program products for WLAN discovery and handover procedures in the coexisted LTE and WLAN networks.

### BACKGROUND OF THE INVENTION

With rapid developments of wireless communication techniques, more and more users expect their UEs, which have WLAN and LTE modes (i.e., dual mode) enabled, to communicate efficiently in the coexisted LTE and WLAN networks. In such coexisted LTE and WLAN networks, a WLAN discovery procedure between a UE and a WLAN AP seems indispensable and how to efficiently trigger this procedure has become a critical factor in implementing dual mode wireless communications. For example, in case a UE is outside the coverage of a WLAN AP in the coexisted LTE and WLAN networks, a WLAN discovery procedure between the UE and the WLAN AP is unnecessary and unwanted. If such an unnecessary WLAN discovery procedure occurs very frequently, it may engender unduly power consumption and shorten the battery life of the UE. Although the above technical deficiencies could be cured by technologies of accurately positioning the UE, such positioning operations may also bring about considerable power consumption due to high signaling overhead and may increase the cost of the UE as well.

In view of the above, it would be desirable to provide methods, apparatuses, and computer program products for triggering a WLAN discovery procedure in the coexisted LTE and WLAN networks in an efficient manner, by which unnecessary WLAN discovery procedures would be refrained from being triggered and better cooperation between LTE and WLAN networks could be achieved. Additionally, such a WLAN discovery procedure can be triggered at different phases in a handover procedure between a UE and BSs.

### SUMMARY OF THE INVENTION

Therefore, there is a need in the art to provide for an efficient way of triggering a WLAN discovery procedure in the coexisted LTE and WLAN networks. Due to an efficient trigger, unnecessary and unwanted WLAN discovery procedures may be eliminated or omitted and thus power consumption that used to be taken by such unnecessary procedures could be saved, thereby giving trigger efficiency a big boost and obtaining a longer battery life for the UE.

The aforementioned and other problems are generally solved or circumvented, and technical advantages are generally achieved, by various embodiments of the present invention, which include methods, apparatuses, and computer program products for triggering a WLAN discovery and handover procedure in the coexisted LTE and WLAN networks, as will be discussed as below.

In an exemplary embodiment of the present invention, a method is provided, which comprises receiving, from a first BS, information that has been exchanged between the first BS and a second BS and that relates to at least one WLAN AP connected or co-located with the first BS or the second BS. The method also comprises performing a WLAN discovery procedure with the at least one WLAN AP based upon the received information.

In one embodiment, the at least one WLAN AP is connected with the first BS or the second BS via a logical control interface.

In another embodiment, the receiving the information comprises receiving the information via an SIB message or a RRC message.

In a further embodiment, the information comprises at least one WLAN SSI and at least one indicator indicative of a type of the at least one WLAN AP.

In an additional embodiment, the WLAN discovery procedure comprises receiving a WLAN discovery request from the first BS via a RRC message, wherein the WLAN discovery request comprises a list of channel numbers and time information for sending or receiving a certain message in the WLAN; and performing the WLAN discovery procedure with the at least one WLAN AP based upon the list of channel numbers, the time information and the WLAN SSID.

In one embodiment, the certain message is a beacon and the performing the WLAN discovery procedure comprises receiving, based upon the list of channel numbers, the time for receiving the beacon and the WLAN SSID, the beacon sent from the WLAN AP.

In another embodiment, the certain message is a probe message and the performing the WLAN discovery procedure comprises sending, based upon the list of channel numbers, the time for sending the probe message and the WLAN SSID, the probe message to the WLAN AP; and receiving a probe response message from the WLAN AP.

In an exemplary embodiment of the present invention, a method is provided, which comprises exchanging, between a first BS and a second BS, information that relates to at least one WLAN AP connected or co-located with the first BS or the second BS. The method also comprises sending the information from the first BS to a UE to perform a WLAN discovery procedure by the UE with the at least one WLAN AP.

In one embodiment, the exchanging comprises exchanging the information via a BS interaction message between the first BS and the second BS.

In another embodiment, the BS interaction message is a BS configuration update message.

In a further embodiment, at least one WLAN AP is connected with the first BS or the second BS via a logical control interface.

In another embodiment, the sending the information comprises sending the information via an SIB message or a RRC message.

In a further embodiment, the information comprises at least one WLAN SSID and at least one indicator indicative of a type of the at least one WLAN AP.

In another embodiment, the method further comprises prioritizing the at least one WLAN AP based at least upon the types of the WLAN APs such that the UE performs the WLAN discovery procedure with the WLAN AP based upon the priority.

In an exemplary embodiment of the present invention, a method is provided, which comprises selecting, at a source BS, at least one WLAN AP that is connected or co-located with a target BS for access by a UE that is to be handed over to the target BS based upon information that has been exchanged between the source BS and the target BS and that relates to at least one WLAN AP connected or co-located with the source BS or the target BS. The method also comprises sending information regarding the at least one selected WLAN AP to the UE to perform a WLAN discovery procedure by the UE with the at least one selected WLAN AP.

In one embodiment, the at least one WLAN AP is connected with the first BS or the second BS via a logical control interface.

In another embodiment, the method further comprises receiving, prior to the selecting, a measurement report from the UE, wherein the measurement report comprises an indicator indicating whether the UE intends to access to a WLAN AP connected or co-located with the target BS.

In an additional embodiment, the sending information regarding the at least one selected WLAN AP comprises sending the information derived from the exchanged information via a measurement control message before initiation of handing over the UE to the target BS.

In a further embodiment, the information comprises at least one WLAN SSID and at least one indicator indicative of a type of the at least one WLAN AP.

In an exemplary embodiment of the present invention, a method is provided, which comprises initiating, at a source BS, a handover request for handing over a UE to a target BS based upon a measurement report, wherein the handover request comprises an indicator indicative of whether the UE intends to access a WLAN AP connected or co-located with the target BS. The method also comprises receiving, from the target BS, information that relates to at least one WLAN AP connected or co-located with the target BS. The method further comprises sending the information to the UE to perform a WLAN discovery procedure by the UE with the at least one WLAN AP.

In one embodiment, the at least one WLAN AP is connected with the source BS or the target BS via a logical control interface.

In a further embodiment, the information comprises at least one WLAN SSID and at least one indicator indicative of a type of the at least one WLAN AP.

In an additional exemplary embodiment of the present invention, an apparatus is provided, which comprises means for receiving, from a first BS, information that has been exchanged between the first BS and a second BS and that relates to at least one WLAN AP connected or co-located with the first BS or the second BS. The apparatus also comprises means for performing a WLAN discovery procedure with the at least one WLAN AP based upon the received information.

In a further exemplary embodiment of the present invention, an apparatus is provided, which comprises means for exchanging, between a first BS and a second BS, information that relates to at least one WLAN AP connected or co-located with the first BS or the second BS. The apparatus also comprises means for sending the information from the first BS to a UE to perform a WLAN discovery procedure by the UE with the at least one WLAN AP.

In an exemplary embodiment of the present invention, an apparatus is provided, which comprises means for selecting, at a source BS, at least one WLAN AP that is connected or co-located with a target BS for access by a UE that is to be handed over to the target BS based upon information that has been exchanged between the source BS and the target BS and that relates to at least one WLAN AP connected or co-located with the source BS or the target BS. The apparatus also comprises means for sending information regarding the at least one selected WLAN AP to the UE to perform a WLAN discovery procedure by the UE with the at least one selected WLAN AP.

In an additional embodiment of the present invention, an apparatus is provided, which comprises means for initiating, at a source BS, a handover request for handing over a UE to a target BS based upon a measurement report, wherein the handover request comprises an indicator indicative of whether the UE intends to access a WLAN AP connected or co-located with the target BS. The apparatus also comprises means for receiving, from the target BS, information that relates to at least one WLAN AP connected or co-located with the target BS. Further, the apparatus comprises means for sending the information to the UE to perform a WLAN discovery procedure by the UE with the at least one WLAN AP.

In one exemplary embodiment of the present invention, an apparatus is provided, which comprises at least one processor and at least one memory including computer program code. The memory and the computer program code are configured to cause the apparatus to receive, from a first BS, information that has been exchanged between the first BS and a second BS and that relates to at least one WLAN AP connected or co-located with the first BS or the second BS. The memory and the computer program code are also configured to cause the apparatus to perform a WLAN discovery procedure with the at least one WLAN AP based upon the received information.

In another exemplary embodiment of the present invention, an apparatus is provided, which comprises at least one processor and at least one memory including computer program code. The memory and the computer program code are configured to cause the apparatus to exchange, between a first BS and a second BS, information that relates to at least one WLAN AP connected or co-located with the first BS or the second BS. The memory and the computer program code are also configured to cause the apparatus to send the information from the first BS to a UE to perform a WLAN discovery procedure by the UE with the at least one WLAN AP.

In a further exemplary embodiment of the present invention, an apparatus is provided, which comprises at least one processor and at least one memory including computer program code. The memory and the computer program code are configured to cause the apparatus to select, at a source BS, at least one WLAN AP that is connected or co-located with a target BS for access by a UE that is to be handed over to the target BS based upon information that has been exchanged between the source BS and the target BS and that relates to at least one WLAN AP connected or co-located with the source BS or the target BS. The memory and the computer program code are also configured to cause the apparatus to send information regarding the at least one selected WLAN AP to the UE to perform a WLAN discovery procedure by the UE with the at least one selected WLAN AP.

In an additional exemplary embodiment of the present invention, an apparatus is provided, which comprises at least one processor and at least one memory including computer program code. The memory and the computer program code are configured to cause the apparatus to initiate, at a source BS, a handover request for handing over a UE to a target BS based upon a measurement report, wherein the handover request comprises an indicator indicative of whether the UE intends to access a WLAN AP connected or co-located with the target BS. The memory and the computer program code are also configured to cause the apparatus to receive, from the target BS, information that relates to at least one WLAN AP connected or co-located with the target BS. Further, the memory and the computer program code are also configured to cause the apparatus to send the information to the UE to perform a WLAN discovery procedure by the UE with the at least one WLAN AP.

In one exemplary embodiment of the present invention, a computer program product is provided, which, comprises at least one computer readable storage medium having a computer readable program code portion stored thereon. The computer readable program code portion comprises program code instructions for receiving, from a first BS, information that has been exchanged between the first BS and a second BS and that relates to at least one WLAN AP connected or co-located with the first BS or the second BS. The computer readable program code portion also comprises program code instructions for performing a WLAN discovery procedure with a WLAN AP based upon the received information.

In an additional embodiment of the present invention, a computer program product is provided, which, comprises at least one computer readable storage medium having a computer readable program code portion stored thereon. The computer readable program code portion comprises program code instructions for exchanging, between a first BS and a second BS, information that relates to at least one WLAN AP connected or co-located with the first BS or the second BS. The computer readable program code portion also comprises program code instructions for sending the information from the first BS to a UE to perform a WLAN discovery procedure by the UE with the at least one WLAN AP.

In another embodiment of the present invention, a computer program product is provided, which, comprises at least one computer readable storage medium having a computer readable program code portion stored thereon. The computer readable program code portion comprises program code instructions for selecting, at a source BS, at least one WLAN AP that is connected or co-located with a target BS for access by a UE that is to be handed over to the target BS based upon information that has been exchanged between the source BS and the target BS and that relates to at least one WLAN AP connected or co-located with the source BS or the target BS. The computer readable program code portion also comprises program code instructions for sending information regarding the at least one selected WLAN AP to the UE to perform a WLAN discovery procedure by the UE with the at least one selected WLAN AP.

In another embodiment of the present invention, a computer program product is provided, which, comprises at least one computer readable storage medium having a computer readable program code portion stored thereon. The computer readable program code portion comprises program code instructions for initiating, at a source BS, a handover request for handing over a UE to a target BS based upon a measurement report, wherein the handover request comprises an indicator indicative of whether the UE intends to access a WLAN AP connected or co-located with the target BS. The computer readable program code portion also comprises program code instructions for receiving, from the target BS, information that relates to at least one WLAN AP connected or co-located with the target BS. Further, the computer readable program code portion also comprises program code instructions for sending the information to the UE to perform a WLAN discovery procedure by the UE with the at least one WLAN AP.

According to certain embodiments of the present invention, a WLAN discovery procedure in the coexisted LTE and WLAN networks has become more efficient, which could be boiled down to efficient trigger manners. Because only needed or necessary WLAN discovery procedures would be carried out, power consumption by those unnecessary WLAN discovery procedures could be obviated, acquiring a longer battery life for the UE.

Other features and advantages of the embodiments of the present invention will also be understood from the following description of specific embodiments when read in conjunction with the accompanying drawings, which illustrate, by way of example, the principles of embodiments of the present invention.

### BRIEF DESCRIPTION OF THE DRAWINGS

The embodiments of the invention that are presented in the sense of examples and their advantages are explained in more detail below with reference to the accompanying drawings, in which:

FIG. 1 is schematic communication architecture of the coexisted LTE and WLAN networks under which various embodiments of the present invention may be practiced;

FIG. 2 is another schematic communication architecture of the coexisted LTE and WLAN networks under which various embodiments of the present invention may be practiced;

FIG. 3 is a flow chart schematically illustrating a method for triggering a WLAN discovery procedure in the coexisted LTE and WLAN networks from a UE perspective according to an embodiment of the present invention;

FIG. 4 is a flow chart schematically illustrating a method for exchanging information regarding at least one WLAN AP between two (H)eNBs according to an embodiment of the present invention;

FIG. 5 is an illustration of information elements to be inserted into a message exchanged between two (H)eNBs according to an embodiment of the present invention;

FIG. 6 is a schematic diagram illustrating a flow of performing a WLAN discovery procedure in the coexisted LTE and WLAN networks according to one embodiment of the present invention;

FIG. 7 is a schematic diagram illustrating a flow of performing a WLAN discovery procedure in the coexisted LTE and WLAN networks according to another embodiment of the present invention;

FIG. 8 is a flow chart schematically illustrating a method for triggering a WLAN discovery procedure in the coexisted LTE and WLAN networks from a BS or (H)eNB perspective according to another embodiment of the present invention;

FIG. 9 is a flow chart schematically illustrating a method for triggering a WLAN discovery procedure before a handover in the coexisted LTE and WLAN networks according to an embodiment of the present invention;

FIG. 10 is a flow chart schematically illustrating a method for triggering a WLAN discovery procedure during a handover in the coexisted LTE and WLAN networks according to another embodiment of the present invention;

FIG. 11 is a flow chart schematically illustrating in detail the methods as illustrated in FIGS. 9 and 10; and

FIG. 12 illustrates schematic block diagrams of a BS and a UE that are suitable for use in practicing the exemplary embodiments of the present invention.

### DETAILED DESCRIPTION OF EMBODIMENTS

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a,” “an” and “the” are not intended to refer to only a singular entity, but include the general class of which a specific example may be used for illustration. The terminology herein is used to describe specific embodiments of the invention, but their usage does not delimit the invention. For example, a BS in the present invention may refer to one of a NB, an eNB, a HeNB, a base transceiver station, a radio BS, and the like and thus they may, as appropriate, be used interchangeably throughout the specification and claims.

Embodiments of the present invention propose an efficient mechanism of triggering WLAN discovery procedures in the coexisted LTE and WLAN networks such that unnecessary WLAN discovery procedures could be eliminated. In an embodiment, information regarding at least one WLAN AP that is connected or co-located with the BSs is exchanged among these BSs. Subsequent to the exchanging, the information is sent to a UE which may intend to access to an AP. Based upon the information, the UE may be aware of which AP(s) it might access to and thereby perform at least one WLAN discovery procedure with the AP(s) until a suitable AP is ascertained. In another embodiment, the information may be included in an SIB or RRC message. In a further embodiment, such information may be transmitted to the UE prior to or during a handover procedure of a UE from a source BS to a target BS. In other embodiments, triggering a WLAN discovery procedure may be implemented by handover decisions made at different stages of a handover.

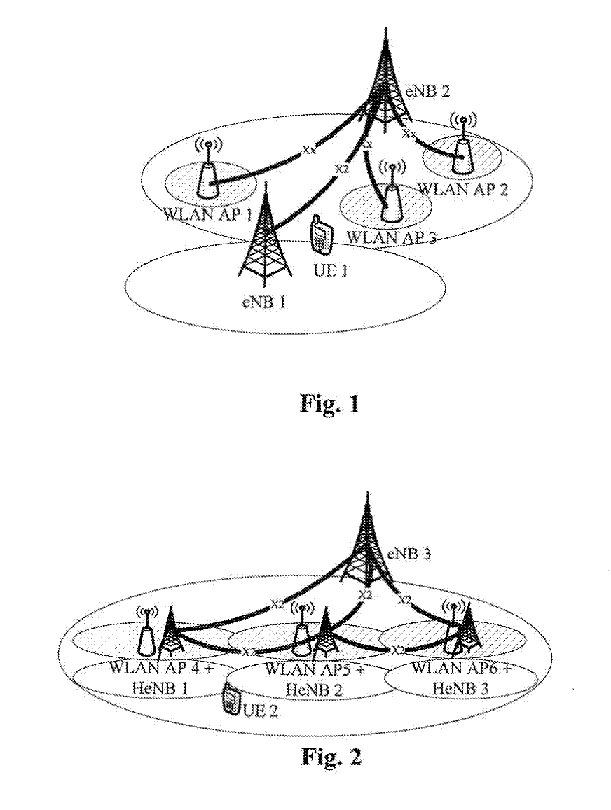

FIG. 1 is schematic communication architecture of the coexisted LTE and WLAN networks under which various embodiments of the present invention may be practiced. As illustrated in FIG. 1, a WLAN AP 1, a WLAN AP 2, and a WLAN AP 3 each is connected to an eNB 2 via an Xx interface which may be a logical control interface and an eNB 1 is connected to the eNB 2 via an X2 interface, thereby forming the coexisted LTE and WLAN networks. It should be noted that the Xx interface is similar to the X2 interface when a WLAN cell covered by a WLAN AP is regarded as a virtual cell served by an eNB. Further, the eNB can control, via this logical control interface, the connected WLAN APs to discover and prepare the access for the UE through a WLAN interface. In the illustrated coexisted LTE and WLAN networks, coverage of each AP and eNB is depicted with an ellipse, and it is apparent that the coverage of an eNB is much larger than that of a WLAN AP.

According to various embodiments of the present invention, a WLAN AP connected with an eNB via an Xx interface is termed a connected type of AP. By means of such a connection, it is assumed that the AP is associated with the eNB and thus is trusted by the eNB. Based upon this trust, communication traffic with respect to a UE 1, as illustrated in FIG. 1 as a mobile phone, may be offloaded to the AP. For example, if the UE 1 has access to the eNB 2 and WLAN AP 3 both, then the communication traffic with respect to the UE 1 can be offloaded by the eNB 2 to the WLAN AP 3 via the Xx interface, which, in turn, forwards the communication traffic to the UE 1.

FIG. 2 is another schematic communication architecture of coexisted LTE and WLAN networks under which various embodiments of the present invention may be practiced. As illustrated in FIG. 2, a WLAN AP 4, a WLAN AP 5, and a WLAN AP 6 each is respectively co-located or even integrated with a HeNB 1, a HeNB 2, and a HeNB 3, which are connected to an eNB 3 and to each other via respective X2 interfaces. In the illustrated coexisted LTE and WLAN networks, coverage of each AP and HeNB is also depicted with an ellipse, and it is known to those skilled in the art that the HeNB is a kind of the eNB and its coverage is substantively close to the WLAN AP.

According to various embodiments of the present invention, a WLAN AP co-located (e.g., integrated) with a HeNB is termed a co-located type of AP. By means of such co-location, communication traffic to a WLAN AP from a UE, such as a UE 2 as illustrated in FIG. 2, can be forwarded to a HeNB, which, in turn, transmits to an eNB via an X2 interface.

It can be understood from the above discussion that the “WLAN offloading” solutions as illustrated in FIGS. 1 and 2 are quite promising for the following reasons. First, from an operator's point of view, these are good ways to support WLAN offloading from the LTE network. Second, from a user's point of view, they can increase data rate and save communication cost. Third, from infrastructure and terminal vendors' point of view, they may play crucial roles in providing more “attractive” connectivity for the end users. Additionally, although two types of the WLAN APs are illustrated separately in FIGS. 1 and 2, it should be noted that these two types of the WLAN APs may be connected to a same eNB or HeNB.

Regarding two types of the WLAN APs, the co-located WLAN APs are more likely to be tightly coupled with an eNB, preferably, a HeNB, due to the similar cell coverage between a WLAN cell and a HeNB/a femto cell. Also, a co-located WLAN AP may share the security mechanism of a HeNB (means open access in WLAN). Further, with respect to a co-located WLAN AP, the user traffic would go through the (H)eNB. Therefore, it is advantageous to allocate a co-located WLAN AP with a higher priority than a connected WLAN AP.

As compared to a co-located WLAN AP, a connected WLAN AP may have less restriction. There exists a backhaul connection between an eNB and a connected WLAN AP and one eNB may be connected with many WLAN APs. The user traffic offloaded by the connected WLAN AP may pass to the eNB via the backhaul connection or may be forwarded to an IP network directly. The security mechanism of connected WLAN APs may be different from that of eNBs and SIM or non-SIM based authentication can be adopted.

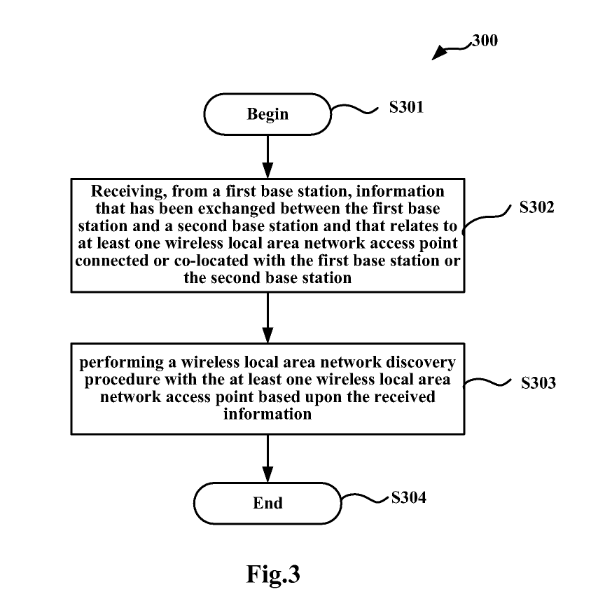

FIG. 3 is a flow chart schematically illustrating a method 300 for triggering a WLAN discovery procedure in the coexisted LTE and WLAN networks from a UE perspective according to an embodiment of the present invention. As illustrated in FIG. 3, the method 300 begins at step S301 and proceeds to step S302, at which the method 300 receives, from a first BS (e.g., one (H)eNB as illustrated in FIG. 1 or 2), information that has been exchanged between the first BS and a second BS (e.g., another (H)eNB as illustrated in FIG. 1 or 2) and that relates to at least one WLAN AP connected or co-located with the first BS or the second BS.

Upon receipt of the information from the first BS, the method 300 proceeds to step S303, at which the method 300 performs a WLAN discovery procedure with at least one WLAN AP based upon the received information. Finally, the method 300 ends at step S304.

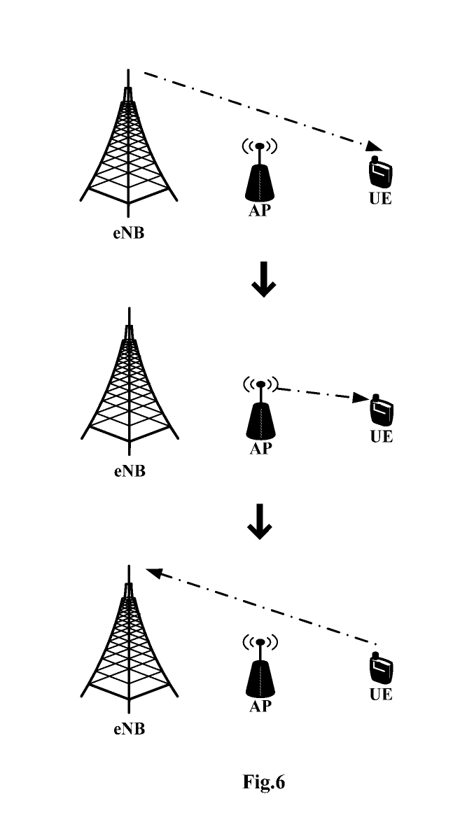

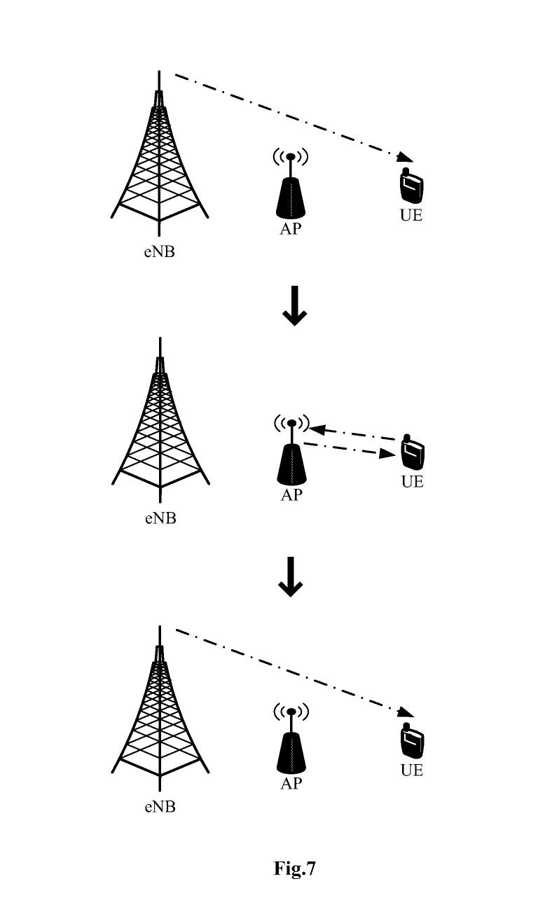

Although not illustrated in FIG. 3, in one embodiment, the at least one WLAN AP is connected with the first BS or the second BS via a logical control interface (i.e., an Xx as noted before). In a further embodiment, the method 300 comprises receiving the information via an SIB or RRC message. The information as received by the UE comprises at least one WLAN SSID and at least one indicator indicative of a type of the at least one WLAN AP, i.e., a connected type or a co-located type as discussed in connection with FIGS. 1 and 2. In addition, although details regarding how to perform a WLAN discovery procedure can be found in pertinent WLAN technical specifications (e.g., 802.11 series), some embodiments of the present invention also provide solutions to significantly improve this discovery procedure, as will be discussed later in relation to FIGS. 6 and 7.

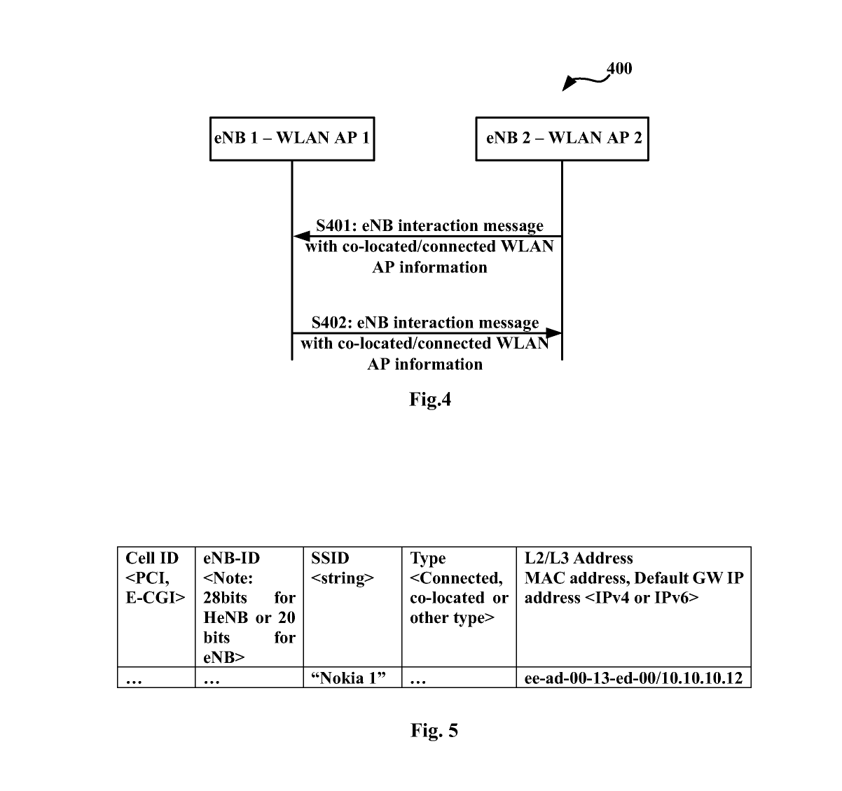

FIG. 4 is a flow chart schematically illustrating a method 400 for exchanging information regarding at least one WLAN AP between two eNBs according to an embodiment of the present invention. As illustrated in FIG. 4, at step S401, the method 400 sends, from an eNB 2 (a.k.a. a first BS), an eNB interaction message, e.g., an eNB configuration update message together with WLAN AP information to an eNB 1, wherein the WLAN AP information may include information of possible connected or co-located WLAN APs (e.g., WLAN AP 2 as illustrated) of the eNB 2. The eNB interaction message can be implemented by extending an X2 or S1 message. Different indicators, as detailed in FIG. 5, may be imported into the message to distinguish the connected WLAN APs (see FIG. 1) from the co-located WLAN APs (see FIG. 2). Upon receipt of the eNB interaction message sent from the eNB 2, the method 400 advances to step S402, at which, the method 400, sends, from the eNB 1 (a.k.a. a second BS), the similar message as sent in Step S401 to the eNB 2. Afterwards, the eNBs 1 and 2 have knowledge of mutual WLAN APs.

FIG. 5 is an illustration of information elements to be inserted into a message exchanged between two eNBs according to an embodiment of the present invention. As illustrated in FIG. 5, the information elements comprise, e.g., a Cell ID, an eNB-ID, an SSID, a Type, and an L2/L3 address of a WLAN AP, and they may be encapsulated into an S1/X2 message. Upon the performance of steps S401 and S402, the mapping between the PCI/E-CGI/eNB ID and the SSID could be established in a form of a table.

Below are discussions with respect to the process of a WLAN discovery procedure in connection with FIG. 6 or 7, in which a schematic diagram illustrating flows of performing the WLAN discovery procedure is provided. According to exemplary embodiments of the present invention, an eNB (e.g., the eNBs as illustrated in FIG. 4) may signal a UE (via an LTE link) and/or one of its AP (a. k. a. WiFi STA, connected with a landline or otherwise to the eNB) to commit the discovery procedures as illustrated in FIGS. 6 and 7. A signal or message transmitted by the eNB to the UE may, as appropriate, include but not be limited to SSIDs, a list of channel numbers and time information for sending or receiving certain messages (e.g., beacons, probe messages, and probe response messages for synchronizing the UE and AP operations for a discovery attempt). If a WLAN discovery is successful, then the eNB may offload data traffic from the LTE network to the WLAN.

As depicted in the upper part of FIG. 6, the eNB may signal (illustrated by a dashed arrow) the UE via a RRC message to passively scan a WLAN message or sequence of messages (e.g., beacons) from the AP, wherein the RRC message may include some parameters, such as SSIDs, a list of channel numbers and a time period, and by extension or as appropriate, may further include information regarding an AP type as discussed previously. Upon receipt of the above signal from the eNB, the flow may proceed to the middle part of FIG. 6, wherein the UE may listen to or scan the beacons from the AP over different WLAN channels at the time as specified by the eNB. Additionally or alternatively, the UE may give feedback on the channel qualities of the different WLAN channels. Afterwards, the eNB could further select, based upon the channel qualities, some better channels from these WLAN channels and inform UE of the selected channels via LTE signalling. Further, based upon this selection, the eNB could also decide on data split, i.e., how big share of the data to transmit over a WLAN link and how much over an LTE link. Then, the flow advances to the bottom part of FIG. 6, wherein the UE may report to the eNB the result of a WLAN discovery procedure on the (selected) channels, i.e., whether the procedure is successful or not.

Instead of performing a WLAN discovery procedure in a passive manner, the WLAN discovery procedure may also be performed in an active manner, as depicted in FIG. 7. At the upper part of FIG. 7, the eNB may signal to the UE the same information as discussed in connection to FIG. 6. After that, the flow advances to the middle part of FIG. 7, wherein the UE may send at least one message (e.g., a probe request message) to the AP and may receive at least one probe response message from the AP. Upon receipt of the probe response message by the UE, the eNB may signal, at the bottom part of FIG. 7 via a RRC message, to the UE about whether the WLAN discovery procedure is successful or not. Similarly, during communication between the UE and WLAN AP, if data message is sent from one party and then an Ack message from the other party is received, then it can be determined that a WLAN discovery procedure has been successful.

Based upon the above discussion, it will be understood by those skilled in the art that the signalling on an LTE side could be implemented, e.g., by using RRC signalling for configuring the UE (to be notified of SSIDs, the channel list and timing information) working under a WLAN to do the measurements. The time instant regarding when to do the measurements can also be signaled via a RRC message, which requires fairly long “activation time” of the order of 20 ms because due to possible RLC and MAC HARQ retransmissions, an RRC message reception time is not known before hand and therefore the measurement activation has to be well. This time could be shortened by not waiting for the feedback and/or asking the beacons to be sent at regular intervals until connectivity has been reached. For example, the eNB could send, e.g., a “WLAN discovery request” RRC message and UE could respond after measurements with a “WLAN discovery response” RRC message reporting the discovered AP. This way a fast discovery and connection setup for a WLAN in the coexisted LTE and WLAN networks can be accomplished and therefore, the signaling cost of the UE could be reduced and power is saved. Further, higher throughput may be achieved in a time-saving way.

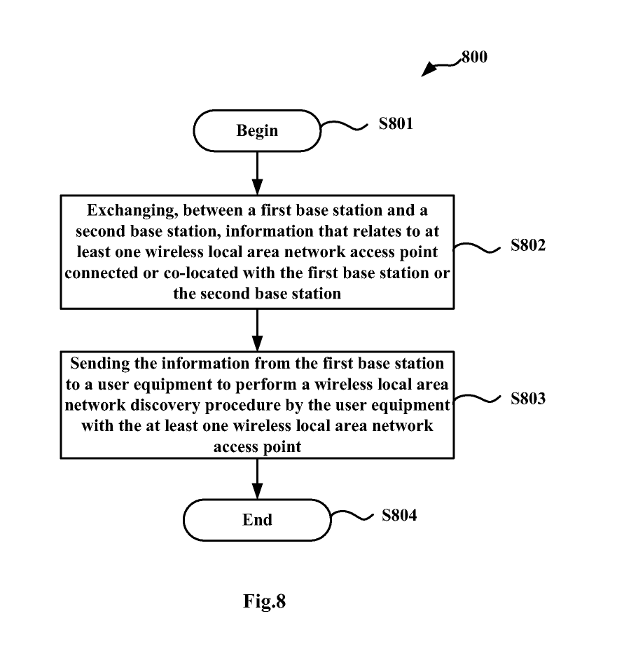

Attention is now directed to FIG. 8, which is a flow chart schematically illustrating a method 800 for triggering a WLAN discovery procedure in the coexisted LTE and WLAN networks from a BS perspective according to another embodiment of the present invention. As illustrated in FIG. 8, the method 800 begins at step S801 and advances to step S802, at which the method 800 exchanges, between a first BS and a second BS (e.g., (H)eNBs 1 and 2 in FIG. 4), information that relates to at least one WLAN AP connected or co-located with the first BS or the second BS, as previously discussed with reference to FIG. 4. Upon exchanging the information, the method 800 advances to step S803, at which the method 800 sends the information from the first BS to a UE to perform a WLAN discovery by the UE with the at least one WLAN AP. Finally, the method 800 ends at step S804.

Although not illustrated in FIG. 8, in one embodiment, the method 800 further prioritizes the at least one WLAN AP based at least upon the types of the WLAN APs such that the UE performs the WLAN discovery procedure with the WLAN AP based upon the priority. For example, a co-located WLAN AP may be given a higher priority than a connected WLAN AP for reasons as discussed before.

Below are some additional discussions with respect to specific implementations in connection with FIGS. 1-8, for facilitating a fully understanding of various embodiments of the present invention.

For a UE in an idle mode for an LTE interface, it may receive SSIDs and AP type information in the system information (e.g., an SIB message) of a camped cell from an eNB. SSID broadcasting might consume some wireless resources but it may facilitate avoiding UE's WLAN interface to blindly search for the surrounding WLAN APs and thus save power consumptions. The reason for an eNB to broadcast an SSID in an SIB could be the willing to offload the traffic of a macro eNB due to the heavy load of an LTE macro cell.

Upon receipt of the SSID and AP type information (connected or co-located), because a WLAN-enabled UE normally is able to “memorize” some credentials for certain SSIDs and thus it may optionally conduct an initial accessibility check to identify which one or ones of the potential WLAN APs it might be able to access to. The way for UE to find accessible SSIDs is left for UE's specific implementation. Thereafter, the UE may perform a WLAN discovery procedure with an accessible WLAN AP with a higher priority. Upon a successful discovery procedure, the UE may connect to a WLAN AP without exiting the idle mode for the LTE interface. In this case, it may only use the WLAN interface for data transmission. Alternatively, the UE may exit the idle mode and utilize both the LTE and WLAN interfaces for data transmission.

For a UE in a connected mode for an LTE interface, a serving eNB may inform the UE of its connected or co-located type of WLAN APs via RRC signaling (possibly with an explicit AP type indicator). In this case, no handover is needed and a WLAN discovery procedure would be triggered if UE needs to transmit data with a WLAN AP.

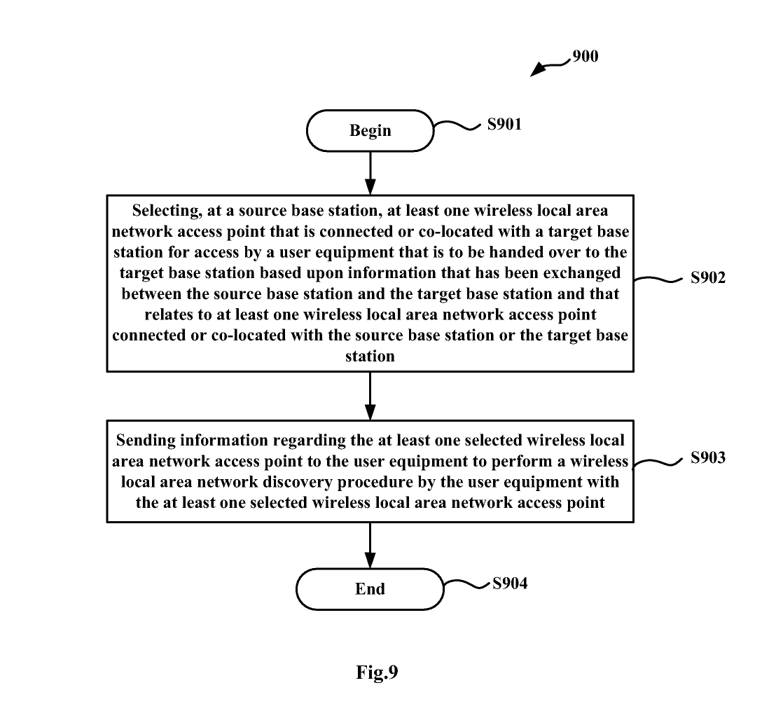

FIG. 9 is a flow chart schematically illustrating a method 900 for triggering a WLAN discovery procedure before a handover in the coexisted LTE and WLAN networks according to an embodiment of the present invention. As illustrated in FIG. 9, the method 900 begins at step S901 and advance to step S902, at which the method 900 selects, at a source BS (e.g., a source (H)eNB), at least one WLAN AP that is connected or co-located with a target BS (e.g., a target (H)eNB) for access by a UE that is to be handed over to the target BS based upon information that has been exchanged between the source BS and the target BS and that relates to at least one WLAN AP connected or co-located with the source BS or the target BS.

Upon a selection of the at least one WLAN AP, the method 900 advances to step S903, at which the method 900 sends information regarding the at least one selected WLAN AP to the UE to perform a WLAN discovery procedure by the UE with the at least one selected WLAN AP. Finally, the method 900 ends at step S904.

Although not illustrated in FIG. 9, in one embodiment, the method 900 further receives, prior to the selecting at step S902, a measurement report from the UE, wherein the measurement report comprises an indicator indicating whether the UE intends to access to a WLAN AP connected or co-located with the target BS. In another embodiment, in the method 900, source BS sends the information derived from the exchanged information via a measurement control message before initiation of handing over the UE to the target BS.

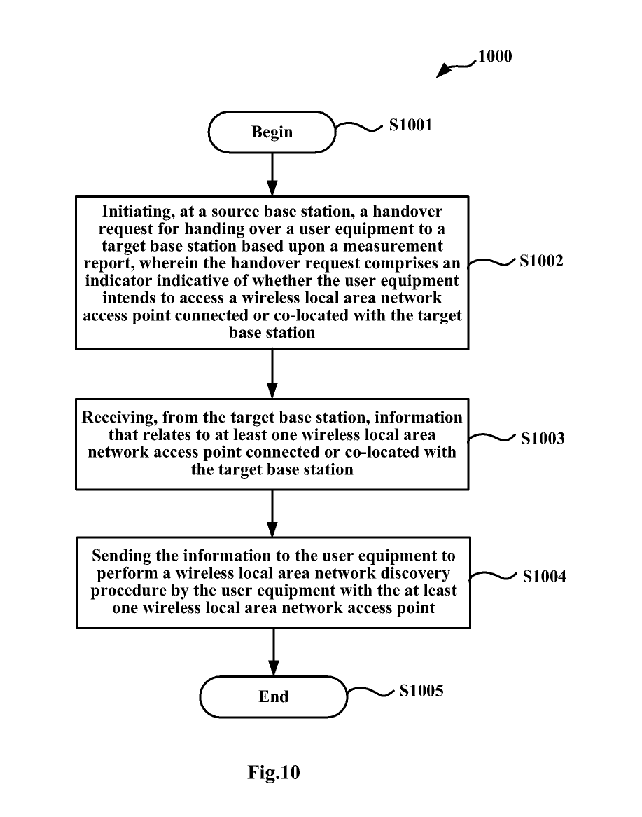

FIG. 10 is a flow chart schematically illustrating a method 1000 for triggering a WLAN discovery procedure during a handover in the coexisted LTE and WLAN networks according to another embodiment of the present invention. As illustrated in FIG. 10, the method 1000 begins at step S1001 and proceeds to step S1002, at which the method 1000 initiates, at a source BS (e.g., a source (H)eNB), a handover request for handing over a UE to a target BS (e.g., a target (H)eNB) based upon a measurement report, wherein the handover request comprises an indicator indicative of whether the UE intends to access a WLAN AP connected or co-located with the target BS.

Upon initiation, the method 1000 proceeds to step S1003, at which the method 1000 receives, from the target BS, information that relates to at least one WLAN AP connected or co-located with the target BS. Then, the method 1000 proceeds to step S1004, at which the method 1000 sends the information to the UE to perform a WLAN discovery procedure by the UE with the at least one WLAN AP. Finally, the method 1000 ends at step S1005.

Although not discussed in connection with FIGS. 8-10, it should be noted that discussions in relation to the information that are exchanged betweens BSs (e.g., eNBs or HeNBs) and types of the WLAN APs are the same as those made in connection with FIGS. 1-5 and thus omitted herein for a clarity purpose.

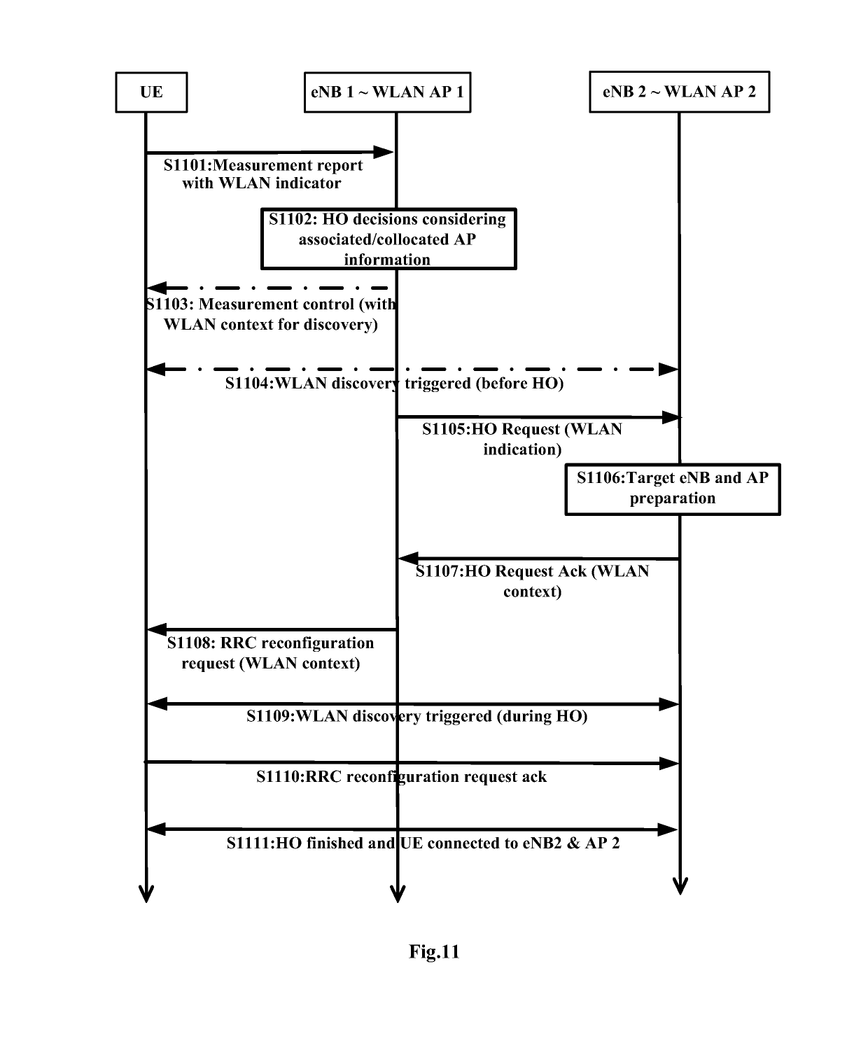

FIG. 11 is a flow chart schematically illustrating in detail the methods as illustrated in FIGS. 9 and 10. As illustrated in FIG. 11, at step S1101, a UE in connected mode may transmit to a serving (H)eNB 1 (i.e., a source BS in an HO procedure) with a WLAN AP 1 a measurement report which may likely trigger an HO procedure. In the measurement report, a WLAN indicator could be inserted to indicate whether the UE intends for WLAN offloading. Upon receipt of the WLAN indicator, the serving eNB 1 would be aware of whether the UE prefers a target (H)eNB 2 (i.e., a target BS in an HO procedure) to prepare a suitable WLAN AP (either connected or co-located) for its access after the HO.

Then, at step S1102, the serving eNB 1, based upon the previously exchanged information as discussed in connection with FIG. 4, checks connected or co-located WLAN APs under neighboring cells to which the UE is likely to be handed over. In particular, the serving eNB 1 can check a mapping table and derive the most likely WLAN APs the UE may connect or access to, which is similar to the step S902 as discussed in the method 900. In case the serving eNB 1 has delivered multiple SSIDs to the UE, co-located WLAN APs of the target eNB 2 should be assigned the higher priorities for reasons as discussed with FIGS. 1 and 2. For example, if the serving eNB 1 broadcasts a list of SSIDs to the UE, it may assign priority indexes to the UE. Simply put, based upon the measurement report and by taking available WLAN APs into account, the eNB 1 makes an HO decision to handover the UE to the target eNB 2 (in this example).

Following completion of the HO decision, the serving eNB 1, at step S1103, sends a measurement control message (via RRC signaling) with WLAN context information to the UE, which is similar to the step S903 as discussed in the method 900. The WLAN context information herein includes the SSID, default GW IP address, and etc, of the available WLAN APs. Thereby, it is possible to trigger, at step S1104, the UE to carry out a WLAN discovery procedure with the WLAN APs prior to the HO since it has WLAN context information of the WLAN APs connected or co-located with the target eNB 2. If the target cell is a macro cell served by a macro eNB, the serving eNB cannot make sure whether the UE can access to the WLAN AP after the HO because the eNB coverage may be much larger than a WLAN cell. Therefore, this trigger manner is more suitable for co-located APs with a target HeNB.

It should be noted that the steps S1103 and S1104, as depicted in dotted lines in FIG. 11, are performed based upon the condition that the eNB 1 have exchanged the information about WLAN APs with the eNB 2 and an appropriate AP (e.g., a WLAN AP 2) could be ascertained. Otherwise, the flow would skip steps S1103 and S1104 and proceed directly to step S1105, at which the eNB 1 sends an HO Request message to the target eNB 2 so as to initiate an HO procedure. The same WLAN indicator as in the measurement report has also been included in the HO Request message. This indicator will trigger the target eNB 2 to prepare, at step S1106, the WLAN APs and include the respective WLAN context in an HO Request Ack message. Here, the preparation may include admission control and authentication is needed. It should be noted that authentication procedures in a WLAN AP using the WLAN context could be implemented or imported independently of the invention.

All things being equal, at step S1107, the target eNB 2 sends the prepared HO Request Ack containing the WLAN context to the serving eNB 1. As mentioned above, the WLAN context includes necessary information for WLAN discovery and fast access such as an SSID, a default GW IP address, and etc. As for a co-located WLAN AP, the target eNB 2 could also provide the WLAN cell preparation results in the HO Request Ack message. In case the WLAN preparation causes some latency, the HO Request Ack message can be sent to the serving eNB 1 without waiting for the end of the WLAN preparation. To this end, a timer can be preset to ensure that the handover latency is not increased due to this preparation. The above steps S1105-S1107 implement the operations as outlined in the steps S1002 and S1003 in the method 1000.

Upon receipt of the HO Request Ack message from the target eNB 2, the serving (source) eNB 1, at step S1108, sends to the UE an RRC reconfiguration request message including the WLAN context information, as outlined in the step S1004 in the method 1000. Upon receiving this message, the UE may be triggered, at step S1109, a WLAN discovery procedure with the WLAN AP 2. In other words, a WLAN discovery procedure has been triggered during an HO procedure.

Then, at step S1110, the UE sends a RRC configuration request Ack message to the target eNB 2 and thereby at step S1111, the HO is finished and the UE has been connected to the target eNB 2 and to the WLAN AP 2.

The foregoing has discussed in connection with FIG. 11 some details of the methods 900 and 1000, which may involve further implemental details or variants than indicated herein; however, the present invention is not limited thereto. Further, it should be noted herein that the steps as illustrated FIG. 11 are only examples and are not restrictive to the present invention. Those skilled in the art, after reading the present specification, can change these steps, for example, by combining or adding certain steps, so as to meet different application demands.

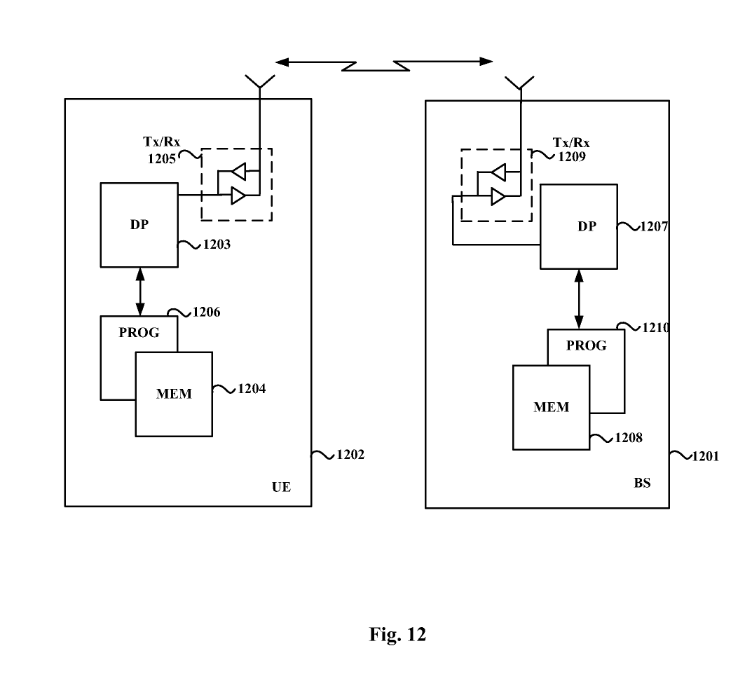

FIG. 12 illustrates a simplified block diagram of a BS 1201 and a UE 1202 that are suitable for use in practicing the exemplary embodiments of the present invention. In FIG. 12, a wireless network is adapted for communication with the UE 1202, via the BS 1201, also referred to as the (H)eNB. The UE 1202 includes a data processor (DP) 1203, a memory (MEM) 1204 coupled to the DP 1203, and a suitable RF transmitter TX and receiver RX 1205 (which need not to be implemented in a same component) coupled to the DP 1203. The MEM 1204 stores a program (PROG) 1206. The TX/RX 1205 is for bidirectional wireless communications with the BS 1201. Note that the TX/RX 1205 has at least one antenna to facilitate communication; multiple antennas may be employed for multiple-input multiple-output MIMO communications in which case the UE 1202 may have multiple TXs and/or RXs.

The BS 1201 includes a data processor (DP) 1207, a memory (MEM) 1208 coupled to the DP 1207, and a suitable RF transmitter TX and receiver RX 1209 coupled to the DP 1207. The MEM 1208 stores a program (PROG) 1210. The TX/RX 1209 is for bidirectional wireless communications with the UE 1202. Note that the TX/RX 1209 has at least one antenna to facilitate communication, though in practice a BS will typically have several. The BS 1201 may be coupled via a data path to at least one external network or system, such as the Internet, for example.

At least one of the PROGs 1206 and 1210 is assumed to include program instructions that, when executed by the associated DPs 1203 and 1207, enable the UE 1202, BS 1201 and a WLAN AP (which may have some similar functional elements to the eNB and is not shown and discussed herein for simplicity) to operate in accordance with the exemplary embodiments of the present invention, as discussed herein with the methods and the flow charts as illustrated in the accompanying drawings.

In general, the various embodiments of the UE 1202 can include, but are not limited to, cellular phones, PDAs having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of the present invention may be implemented by computer software executable by at least one of the DPs 1203, 1207 of the UE 1202 and the BS 1201, or by hardware, or by a combination of software and hardware.

The MEMs 1204 and 1208 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the BS 1201 or UE 1202, there may be several physically distinct memory units in the BS 1201 or UE 1202. The DPs 1203 and 1207 may be of any type suitable to the local technical environment, and may include at least one of general purpose computers, special purpose computers, microprocessors, digital signal processors (DSPs) and processors based on multicore processor architecture, as non-limiting examples. Either or both of the UE 1202 and the BS 1201 may have multiple processors, such as for example an application specific integrated circuit chip that is slaved in time to a clock which synchronizes the main processor.

Exemplary embodiments of the present invention have been described above with reference to block diagrams and flowchart illustrations of methods, apparatuses (i.e., systems). It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment of the invention comprises at least one computer readable storage medium, on which the foregoing computer program instructions are stored. The computer readable storage medium can be, for example, an optical compact disk or an electronic memory device like a RAM (random access memory) or a ROM (read only memory).

Various abbreviations that appear in the specification and/or in the drawing figures are defined as below:

AP Access Point

3GPP the 3rd Generation Partnership Project

Ack Acknowledgement

BS Base Station

E-CGI E-UTRAN Cell Global Identifier

eNB evolved Node B

GW Gateway

HeNB Home eNB

HO Handover

ID Identify

IM Instant Message

IP Internet Protocol

L2/L3 Layer 2/Layer 3

LAN Local Area Network

LTE Long Term Evolution

NB Node B

PDA Personal Digital Assistants

PCI Physical Cell Identifier

RRC Radio Resource Control

STA Station

UE User Equipment

UTRAN Universal Terrestrial Radio Access Network

WLAN Wireless Local Area Network

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-34. (canceled)

35. A method, comprising:
receiving, from a first base station via at least one of system information block message and radio resource control message, information that has been exchanged between the first base station and a second base station and that relates to at least one wireless local area network access point connected or co-located with the first base station or the second base station; and
performing a wireless local area network discovery procedure with the at least one wireless local area network access point based upon the received information.

36. The method as recited in claim 36, wherein the at least one wireless local area network access point is connected with the first base station or the second base station via a logical control interface.

37. The method as recited in claim 36, wherein the information comprises at least one wireless local area network service set identifier and at least one indicator indicative of a type of the at least one wireless local area network access point.

38. The method as recited in claim 37, wherein the performing the wireless local area network discovery procedure comprises:
receiving a wireless local area network discovery request from the first base station via a radio resource control message, wherein the wireless local area network discovery request comprises a list of channel numbers and time information for sending or receiving a certain message in the wireless local area network; and
performing the wireless local area network discovery procedure with the at least one wireless local area network access point based upon the list of channel numbers, the time information and the wireless local area network service set identifier.

39. The method as recited in claim 38, wherein the certain message is a beacon and the performing the wireless local area network discovery procedure comprises receiving, based upon the list of channel numbers, the time for receiving the beacon and the wireless local area network service set identifier, the beacon sent from the wireless local area network access point.

40. The method as recited in claim 38, wherein the certain message is a probe message and the performing the wireless local area network discovery procedure comprises:
sending, based upon the list of channel numbers, the time for sending the probe message and the wireless local area network service set identifier, the probe message to the wireless local area network access point; and
receiving a probe response message from the wireless local area network access point.

41. An apparatus, comprising:
at least one processor and at least one memory including computer program code,
the memory and the computer program code configured to cause the apparatus to:
receive, from a first base station via at least one of system information block message and radio resource control message, information that has been exchanged between the first base station and a second base station and that relates to at least one wireless local area network access point connected or co-located with the first base station or the second base station; and
perform a wireless local area network discovery procedure with the at least one wireless local area network access point based upon the received information.

42. The apparatus as recited in claim 41, wherein the at least one wireless local area network access point is connected with the first base station or the second base station via a logical control interface.

43. The apparatus as recited in claim 41, wherein the information comprises at least one wireless local area network service set identifier and at least one indicator indicative of a type of the at least one wireless local area network access point.

44. The apparatus as recited in claim 43, wherein the performing the wireless local area network discovery procedure comprises:
receiving a wireless local area network discovery request from the first base station via a radio resource control message, wherein the wireless local area network discovery request comprises a list of channel numbers and time information for sending or receiving a certain message in the wireless local area network; and
performing the wireless local area network discovery procedure with the at least one wireless local area network access point based upon the list of channel numbers, the time information and the wireless local area network service set identifier.

45. The apparatus as recited in claim 44, wherein the certain message is a beacon and the performing the wireless local area network discovery procedure comprises receiving, based upon the list of channel numbers, the time for receiving the beacon and the wireless local area network service set identifier, the beacon sent from the wireless local area network access point.

46. The apparatus as recited in claim 44, wherein the certain message is a probe message and the performing the wireless local area network discovery procedure comprises:
sending, based upon the list of channel numbers, the time for sending the probe message and the wireless local area network service set identifier, the probe message to the wireless local area network access point; and
receiving a probe response message from the wireless local area network access point.

47. An apparatus, comprising:
at least one processor and at least one memory including computer program code,
the memory and the computer program code configured to cause the apparatus to:
exchange, between the apparatus and a base station, information that relates to at least one wireless local area network access point connected or co-located with the apparatus or the base station; and
send the information to enable a user equipment to perform a wireless local area network discovery procedure with the at least one wireless local area network access point.

48. The apparatus as recited in claim 47, wherein the exchanging comprises exchanging the information via an interaction message between the apparatus and the base station.

49. The apparatus as recited in claim 48, wherein the interaction message is a base station configuration update message.

50. The apparatus as recited in claim 47, wherein the at least one wireless local area network access point is connected with the apparatus or the base station via a logical control interface.

51. The apparatus as recited in claim 47, wherein the sending the information comprises sending the information via a system information block message or a radio resource control message.

52. The apparatus as recited in claim 47, wherein the information comprises at least one wireless local area network service set identifier and at least one indicator indicative of a type of the at least one wireless local area network access point.

53. The apparatus as recited in claim 47, further comprising:
prioritizing the at least one wireless local area network access point based at least upon the types of the wireless local area network access points such that the user equipment performs the wireless local area network discovery procedure with the wireless local area network access point based upon the priority.
